(19) United States
(12) Patent Application Publication
(10) Pub. No.: US 2020/0152944 A1
(43) Pub. Date: May 14, 2020

(54) MANUFACTURING DEVICE FOR ELECTRODE ASSEMBLY

(71) Applicant: Murata Manufacturing Co., Ltd., Nagaokakyo-shi (JP)

(72) Inventors: MASAYUKI Sumita, Nagaokakyo-shi (JP); Makoto Ooike, Nagaokakyo-shi (JP); Hideyasu Kamigawa, Nagaokakyo-shi (JP)

(21) Appl. No.: 16/743,155

(22) Filed: Jan. 15, 2020

Related U.S. Application Data
(63) Continuation of application No. PCT/JP2018/020291, filed on May 28, 2018.

(30) Foreign Application Priority Data
Jul. 18, 2017 (JP) 2017-139001

(51) Int. Cl. H01M 2/16; B25J 15/06; B25J 13/08; B25J 19/04

(52) U.S. Cl. CPC H01M 2/1673; B25J 19/04; B25J 13/088; B25J 15/0683

(57) ABSTRACT

A manufacturing device for manufacturing an electrode assembly by laminating unit electrode assemblies in each of which an electrode is placed on a separator. The device includes a transferring device that includes a sucking plate and transfers, onto the positional adjustment stage, each of the unit electrode assemblies sucked up by the sucking plate. Moreover, an image capturing device captures an image of the electrode of each of the unit electrode assemblies placed on the positional adjustment stage. A positional adjustment device positionally adjusts the positional adjustment stage based on the image of the electrode captured, and a transferring and laminating device picks up each unit electrode assembly and transfers each to a lamination stage and performs a lamination process. At least part of the sucking plate is transparent and the image capturing device captures an image of the electrode from above the transparent portion of the sucking plate.

### CROSS REFERENCE TO RELATED APPLICATIONS

The present application is a continuation of PCT/JP2018/020291 filed May 28, 2018, which claims priority to Japanese Patent Application No. 2017-139001, filed Jul. 18, 2017, the entire contents of each of which are incorporated herein by reference.

### TECHNICAL FIELD

The present invention relates to a manufacturing device for manufacturing an electrode assembly by laminating a plurality of unit electrode assemblies each including an electrode adhered to a separator.

### BACKGROUND ART

Conventionally, for electrode assemblies for battery, electrode assemblies are used that each have a structure in which positive electrodes and negative electrodes are alternatively laminated with a separator interposed therebetween.

As a manufacturing method of such an electrode assembly, Patent Document 1 (identified below) discloses a method for manufacturing an electrode assembly by preparing a laminate by laminating a separator material in a strip shape, a positive electrode, a separator material in a stripe shape, and a negative electrode in this order, cutting the laminate into a predetermined shape thereby to produce a unit structure, and laminating a plurality of such unit structures thus produced.

In this regard, such a method is also conceivable that, instead of preparing such a unit structure with the four-layered laminate of the separator, the positive electrode, the separator, and the negative electrode, a unit electrode assembly in each of which an electrode is adhered to a separator is prepared and a plurality of such unit electrode assemblies thus produced are laminated with each other thereby to produce an electrode assembly. That is, an electrode assembly is produced by alternatively laminating a plurality of unit electrode assemblies in which a positive electrode is adhered to a separator and a plurality of unit electrode assemblies in which a negative electrode is adhered to a separator.

In such a case, such a method is also conceivable that the plurality of unit electrode assemblies is laminated after being positionally adjusted by a method described below.

To begin with, a transferring device with a sucking plate sucks up a unit electrode assembly by using the sucking plate and transfers the unit electrode assembly that is sucked up onto a positional adjustment stage. After the transferring device withdraws from the positional adjustment stage, an image of the unit electrode assembly is captured from above by using an image capturing device.

After that, based on the image of the unit electrode assembly thus captured, the position of the positional adjustment stage is adjusted. Finally, a transferring and laminating device picks up the unit electrode assembly from the positional adjustment stage thus positionally adjusted, transfers the unit electrode assembly to a laminating stage and performs lamination process with the unit electrode assembly on the laminating stage.

By repeating these operations, it is possible to produce an electrode assembly in which a plurality of unit electrode assemblies is laminated.
Patent Document 1: Japanese Patent Application

Laid-Open No. 2015-528629.

However, the manufacturing method for the electrode assembly as described above has such a drawback that the capturing of the image of the unit electrode assembly cannot be performed until the transferring device completely withdraws from the positional adjustment stage after the transferring device has transferred the unit electrode assembly thereon. As such, this conventional method has limited production efficiency in this regard.

### SUMMARY OF THE INVENTION

Accordingly, the exemplary embodiment of the present invention provides such a manufacturing device for an electrode assembly that improves the production efficiency for the electrode assembly by capturing an image of a unit electrode assembly by using an image capturing device before a transferring device withdraws from a positional adjustment stage completely.

According to the present invention, manufacturing device is provide for manufacturing an electrode assembly by laminating a plurality of unit electrode assemblies in each of which an electrode is adhered to a separator. In this aspect, the manufacturing device includes a positional adjustment stage; a transferring device including a sucking plate and being configured to transfer, onto the positional adjustment stage, each of the unit electrode assemblies sucked up by the sucking plate; an image capturing device configured to capture an image of the electrode of each of the unit electrode assemblies placed on the positional adjustment stage; and a positional adjustment device configured to positionally adjust the positional adjustment stage on a basis of the image of the electrode thus captured by the image capturing device, with each of the unit electrode assemblies placed on the positional adjustment stage. The manufacturing device further includes a transferring and laminating device configured to pick up each of the unit electrode assemblies from the positional adjustment stage thus positionally adjusted by the positional adjustment device, transfer each of the unit electrode assemblies to a predetermined laminating position, and perform lamination process with each of the unit electrode assemblies. In addition, at least part of the sucking plate is a transparent portion, which is a transparent, and the image capturing device is configured to capture the image in such a way that the image capturing device captures an image of at least part of the electrode of each of the unit electrode assemblies on the positional adjustment stage from above via the transparent portion of the sucking plate.

In an exemplary aspect, the image capturing device can be configured to capture the image of the electrode of each of the unit electrode assemblies held between the positional adjustment stage and the sucking plate.

In an exemplary aspect, the positional adjustment device can be configured to start the positional adjustment of the positional adjustment stage while the transferring device is withdrawing after the transferring device transfers each of the unit electrode assemblies onto the positional adjustment stage.

In an exemplary aspect, the positional adjustment stage can be transparent or translucent, and the manufacturing device can further include a lighting device configured to emit illuminating light to each of the unit electrode assemblies from below the positional adjustment stage when the image capturing device performs the capturing of the image.

According to the exemplary embodiments described herein, the sucking plate for sucking up a unit electrode assembly is configured such that at least part of the sucking plate is a transparent portion, and an image capturing device is configured to capture an image of the electrode of the unit electrode assembly placed on a positional adjustment stage from above via the transparent portion of the sucking plate. With this configuration, the capturing of the image of the unit electrode assembly can be performed by the image capturing device before the transferring device withdraws completely from the positional adjustment stage after the transferring device has transferred the unit electrode assembly onto the positional adjustment stage. Therefore, after that, it is possible to start the positional adjustment of the positional adjustment stage according to the captured image promptly. Thus, it is possible to improve the production efficiency for the unit electrode assembly.

### BRIEF DESCRIPTION OF DRAWINGS

FIG. 1 is a cross-sectional view illustrating a structure of an electrode assembly.

FIG. 2(a) is a side view illustrating a structure of a manufacturing device for the electrode assembly according to one embodiment, and FIG. 2(b) is a top view of the manufacturing device for the electrode assembly illustrated in FIG. 2(a).

FIG. 3(a) is a perspective view illustrating an exterior appearance of a transferring device, and FIG. 3(b) is a side view of the transferring device.

FIG. 4 is a view for explaining a positional adjustment direction of a positional adjustment stage.

FIG. 5 is a view for explaining a method for manufacturing an electrode assembly by using a manufacturing device for the electrode assembly according to one embodiment.

### DETAILED DESCRIPTION

In the following description, exemplary embodiments of this invention will be described to explain the characteristic features of this invention more concretely.

To begin with, a structure of an electrode assembly manufactured by a manufacturing device for the electrode assembly will be described. The electrode assembly is applicable for use in batteries such as lithium ion batteries, for example.

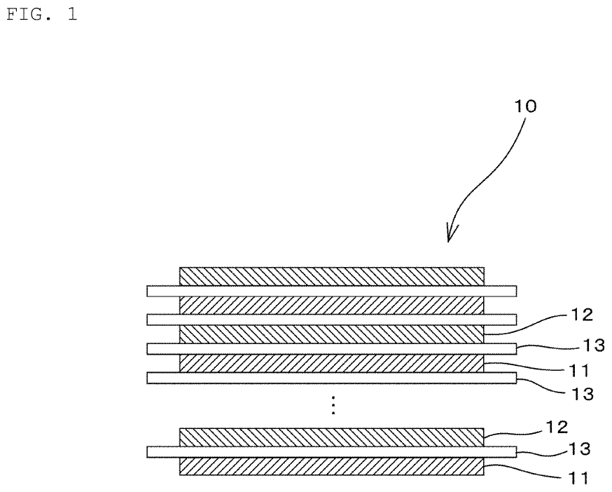

FIG. 1 is a cross-sectional view illustrating a structure of an electrode assembly 10. The electrode assembly 10 has such a structure that a plurality of positive electrodes 11 and a plurality of negative electrodes 12 are laminated alternatively with a separator 13 interposed therebetween.

Each of the positive electrodes 11 includes a positive electrode current collector formed as a foil of a metal such as aluminum, and positive electrode active material layers respectively formed on both sides of the positive electrode current collector. In an exemplary aspect, the positive electrode active material layer can contain lithium cobaltate as a positive electrode active material, for example. If a positive electrode is located to be outermost of the electrode assembly 10 in a lamination direction, the electrode located to be outermost may be configured to include a positive electrode active material layer only on one side of the positive electrode current collector.

Each of the negative electrodes 12 includes a negative electrode current collector formed as a foil of a metal such as copper, and negative electrode active material layers respectively formed on both sides of the negative electrode current collector. The negative electrode active material layer may contain black lead as a negative electrode active material, for example. If a negative electrode is located to be outermost of the electrode assembly 10 in the lamination direction, the negative electrode located to be outermost may be configured to include a negative electrode active material layer only on one side of the negative electrode current collector. The negative electrodes 12 may be identical with or different from the positive electrodes 11 in shape and size.

The separator 13 may be a microporous thin film made from polypropylene excellent in electrical insulation property, for example.

The electrode assembly 10 having a structure described above can be prepared, for example, by alternatively laminating a plurality of first unit electrode assemblies in each of which the positive electrode 11 is adhered to the separator 13, and a plurality of second unit electrode assemblies in each of which the negative electrode 12 is adhered to the separator 13. Unit electrode assemblies in each of which either the positive electrode 11 or the negative electrode 12 is adhered to the separator 13, like the first unit electrode assemblies and the second unit electrode assemblies can be prepared, for example, by placing an electrode on a separator material in a strip shape, pressure-bonding the electrode to the separator, and cutting the separator material along periphery of the electrode into a predetermined shape.

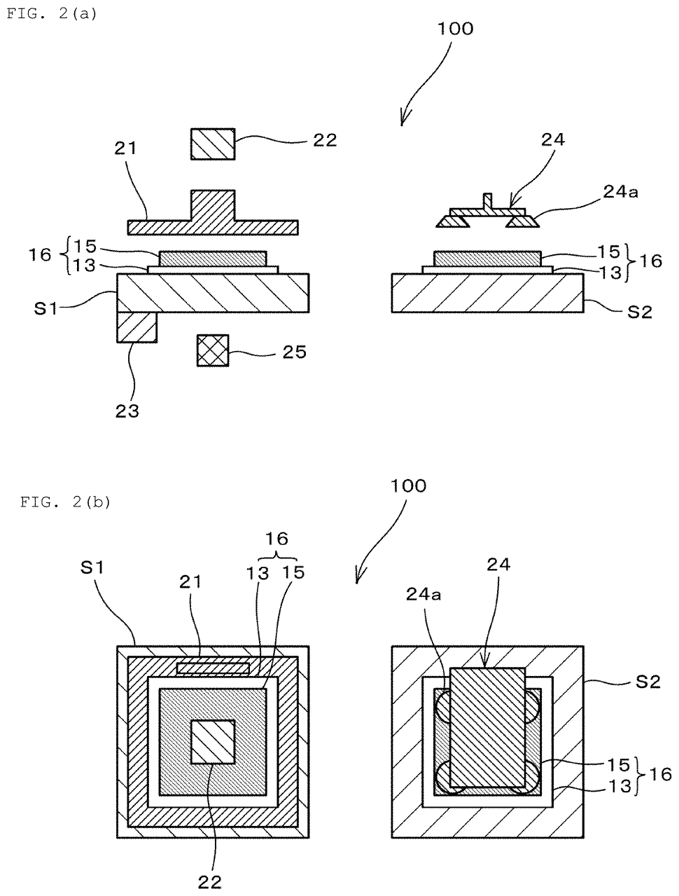

FIG. 2(a) is a side view illustrating a structure of a manufacturing device 100 for the electrode assembly according to one embodiment. Furthermore, FIG. 2(b) is a top view of the manufacturing device 100 for the electrode assembly illustrated in FIG. 2(a). It should be noted that FIG. 2(b) only illustrates things located above a positional adjustment stage S1 described later.

The manufacturing device 100 for the electrode assembly according to one embodiment includes a transferring device 21, an image capturing device 22, a positional adjustment device 23, a transferring and laminating device 24, a lighting device 25, a positional adjustment stage S1, and a laminating stage S2.

The transferring device 21 is a device configured to pick up a unit electrode assembly 16 at a predetermined pick-up position, and transfer the unit electrode assembly 16 onto the positional adjustment stage S1. The unit electrode assembly 16 has such a structure that the electrode 15 is adhered to the separator 13, as described above. The electrode 15 is a positive electrode 11 or a negative electrode 12.

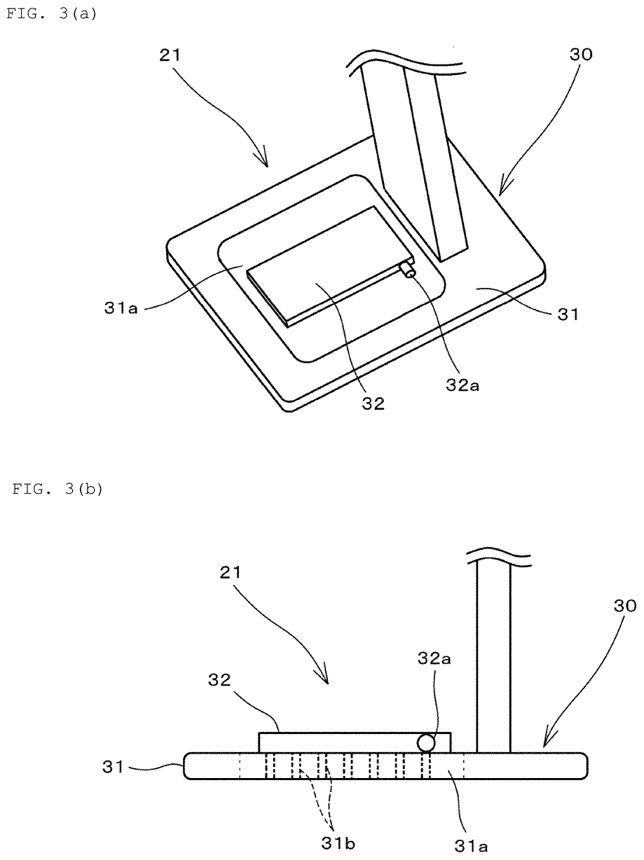

FIG. 3(a) is a perspective view illustrating an exterior appearance of the transferring device 21, and FIG. 3(b) is a side view of the transferring device 21.

The transferring device 21 includes a sucking plate 30 configured to suck up the unit electrode assembly 16. Moreover, in the exemplary aspect, the sucking plate 30 includes a flat plate portion 31 and a sucking chamber 32.

The sucking chamber 32 includes a sucking hose opening 32a, and is located on a top surface of the flat plate portion 31. The sucking chamber 32 is transparent. Furthermore, the sucking hose opening 32a is connected to a sucking hose of a sucking device (not illustrated).

The flat plate portion 31 has a plurality of sucking pores 31b penetrating from the top surface to a bottom surface.

In order to suck up a unit electrode assembly 16 by using the sucking plate 30, sucking by the sucking device (e.g., creating a vacuum pressure) is started. As a result of this process, the unit electrode assembly 16 located below the flat plate portion 31 is sucked up via the sucking chamber 32 and the plurality of sucking pores 31b provided on the flat plate portion 31, thereby sucking the unit electrode assembly 16 onto a bottom surface of the flat plate portion 31.

The flat plate portion 31 of the sucking plate 30 is configured such that at least part of the flat plate portion 31 is a transparent portion 31a, i.e., which is transparent. As long as the transparent portion 31a is so light-transmitting that an amount of light enough to make it possible for the image capturing device 22 (described later) to capture an image of the electrode 15 of the unit electrode assembly 16, the transparent portion 31a is not necessarily completely transparent. For example, the transparent portion 31a is formed from a resin such as acrylic resin, polyethylene terephthalate resin, polycarbonate resin, or vinyl chloride resin, glass, or the like. It should be noted that the material for forming the transparent portion 31a is not limited to these materials.

It is also noted that the flat plate portion 31 may be wholly the transparent portion 31a, while this embodiment is configured such that part of the flat plate portion 31 is the transparent portion 31a.

The image capturing device 22 is configured to capture an image of the electrode 15 of the unit electrode assembly 16 via the transparent portion 31a of the sucking plate 30 from above, with the electrode 15 having been placed on the positional adjustment stage S1 by the transferring device 21 and being held between the positional adjustment stage S1 and the sucking plate 30 of the transferring device 21. In doing this, as long as position and inclination of the electrode 15 under the image capturing can be determined, the image capturing may capture an image of only part of the electrode 15 rather than the whole part of the electrode 15.

In this exemplary embodiment, the image capturing captures the image of the electrode 15 in such a way that an outer shape of the electrode 15 with a tab thereof can be determined. Therefore, the sucking hose opening 32a, which is not transparent, is positioned at a position at which the sucking hose opening 32a will not disturb the capturing of the image of the electrode 15, such as a position at which sucking hose opening 32a will overlap with the tab of the electrode 15 in the vertical direction when the unit electrode assembly 16 is sucked up on the bottom surface of the sucking plate 30.

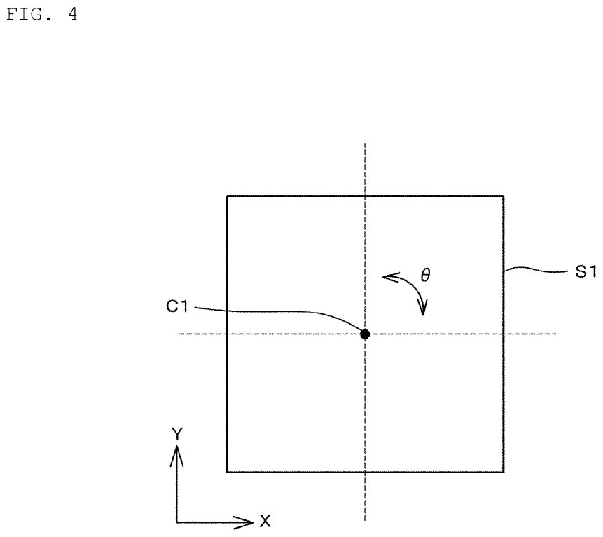

The positional adjustment stage S1 is configured to be movable in the X axis direction and the Y axis direction as illustrated in FIG. 4, and a θ direction, which is a rotating direction about the center C1 of the positional adjustment stage S1. The positional adjustment device 23 is configured to perform, based on the image of the electrode 15 of the unit electrode assembly 16 captured by the image capturing device 22, the positional adjustment of the positional adjustment stage S1 by moving, in at least one direction among the X axis direction, the Y axis direction, and the θ direction, the positional adjustment stage S1 with the unit electrode assembly 16 placed thereon.

The transferring and laminating device 24 is configured to pick up the unit electrode assembly 16 on the positional adjustment stage S1 thus positionally adjusted, and to transfer the unit electrode assembly 16 to the laminating stage S2, which is a predetermined position for performing the laminating. This embodiment is so configured that the transferring and laminating device 24 includes a sucking pad 24a for sucking up the unit electrode assembly 16, and is configured to pick up the unit electrode assembly 16 by sucking up the unit electrode assembly 16 by using the sucking pad 24a.

The transferring and laminating device 24 does not perform the positional adjustment of the unit electrode assembly 16 in laminating a plurality of the unit electrode assemblies 16 in order on the laminating stage S2. That is, the transferring and laminating device 24 is configured to pick up the unit electrode assembly 16 thus positionally adjusted by the positional adjustment of the positional adjustment stage S1, and transfer the unit electrode assembly 16 to the laminating stage S2, so that the transferring and laminating device 24 will laminate a plurality of the unit electrode assemblies 16 at a substantially same position on the laminating stage S2.

In addition, the lighting device 25 is positioned below the positional adjustment stage S1 and configured to emit illuminating light to the unit electrode assembly 16 when the image capturing device 22 is performing the capturing of the image of the unit electrode assembly 16. According to the exemplary aspect, this embodiment is so configured that the positional adjustment stage S1 is translucent, so that the illuminating light can pass through the positional adjustment stage S1. However, the positional adjustment stage S1 may be transparent.

It should be noted that the lighting device 25 may be integrated with the positional adjustment stage S1 or may be built in the positional adjustment stage S1.

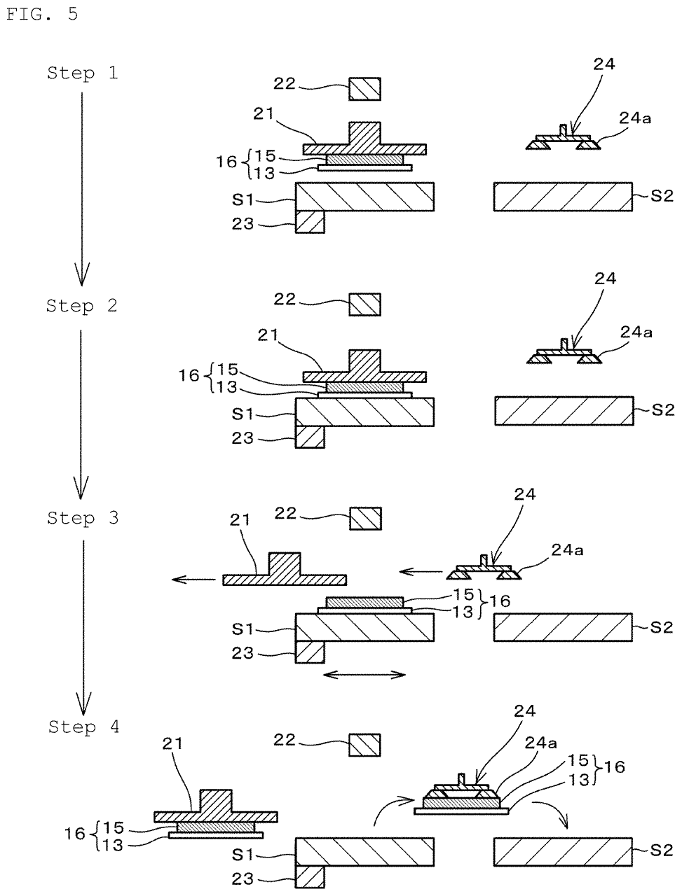

FIG. 5 is a view for explaining a method for manufacturing an electrode assembly 10 by using a manufacturing device 100 for the electrode assembly according to one embodiment. In FIG. 5, the lighting device 25 is omitted.

At Step 1, the transferring device 21 picks up a unit electrode assembly 16 from a predetermined pick-up position, and transfers the unit electrode assembly 16 onto the positional adjustment stage S1. More specifically, the transferring device 21 transfers the unit electrode assembly 16 with the electrode 15 of the unit electrode assembly 16 overlapped with the transparent portion 31a of the flat plate portion 31 of the transferring device 21 in the vertical direction.

However, in an exemplary aspect, it is not necessary that the whole electrode 15 overlap with the transparent portion 31a of the flat plate portion 31, and the electrode 15 may partially overlap with the transparent portion 31a as long as that portion overlapping with the transparent portion 31a is a portion that allows to determine the position and inclination of the electrode 15, such as a corner portion of the electrode 15.

At step 2 subsequent to Step 1, the unit electrode assembly 16 is placed on the positional adjustment stage S1. The image capturing device 22 captures an image of the electrode 15 of the unit electrode assembly 16 via the transparent portion 31a of the sucking plate 30 from above, while the unit electrode assembly 16 is placed on the positional adjustment stage S1 and held between the positional adjustment stage S1 and the sucking plate 30 of the transferring device 21.

The lighting device 25 illuminates the unit electrode assembly 16 with the illuminating light from below the positional adjustment stage S1 when the image capturing device 22 performs the image capturing. The illuminating light is projected from below the unit electrode assembly 16 because, when the electrode 15 includes a foil of a metal such as aluminum, illuminating light projected from above the electrode 15 would reflect from the electrode 15, thereby making it difficult to capture the image of the electrode 15.

That is, by illuminating the unit electrode assembly 16 with the illuminating light from there below by using the lighting device 25, it is possible to prevent the reflection of illumination from a top surface of the electrode 15, thereby making it possible to capture the image as intended.

As described above, the image capturing device 22 captures the image of the electrode 15 of the unit electrode assembly 16 on the positional adjustment stage S1 via the transparent portion 31a of the sucking plate 30 from there above. This enables the image capturing device 22 to start the capturing of the image of the electrode 15 of the unit electrode assembly 16 before the transferring device 21 completely withdraws from the positional adjustment stage S1 after the transferring device 21 has transferred the unit electrode assembly 16 thereto. Thus, it is possible for the positional adjustment device 23 to start the positional adjustment of the positional adjustment stage S1 on the basis of the captured image soon after this, thereby making it possible to improve the production efficiency of the electrode assembly 10.

Furthermore, the image capturing device 22 captures the image of the unit electrode assembly 16 while the unit electrode assembly 16 is held between the positional adjustment stage S1 and the sucking plate 30. Therefore, even if the unit electrode assembly 16 is warped, it is possible to capture an image of the unit electrode assembly 16 as an unwarped unit by being held between the positional adjustment stage S1 and the sucking plate 30. This makes it possible to determine the position and inclination of the electrode 15 in the captured image with accuracy, thereby making it possible to perform accurate positional adjustment of the positional adjustment stage S1.

At Step 3 subsequent to Step 2, the transferring device 21 starts to withdraw from the positional adjustment stage S1, so that the transferring device 21 will pick up a next unit electrode assembly 16.

While the transferring device 21 is withdrawing, the positional adjustment device 23 performs the positional adjustment of the positional adjustment stage S1 on the basis of the image of the electrode 15 thus captured by the image capturing device 22. More specifically, the positional adjustment device 23 causes the positional adjustment stage S1 to move in at least one direction among the X axis direction, the Y axis direction, and the el direction, on the basis of the position and inclination of the electrode 15 in the captured image, thereby positionally adjusting the positional adjustment stage S1.

In this embodiment, the positional adjustment device 23 starts the positional adjustment of the positional adjustment stage S1 substantially at the same time when the transferring device 21 starts to withdraw from the positional adjustment stage S1.

Because the positional adjustment device 23 starts the positional adjustment of the positional adjustment stage S1 while the transferring device 21 is withdrawing as described above, the positional adjustment of the positional adjustment stage S1 can be started promptly without the need of waiting for the transferring device 21 to withdraw from the positional adjustment stage S1 completely.

Furthermore, while the transferring device 21 is moving to withdraw from the positional adjustment stage S1 and to pick up the next unit electrode assembly 16, the transferring and laminating device 24 moves to the positional adjustment stage S1 in order to pick up the unit electrode assembly 16 on the positional adjustment stage S1.

The aforementioned step of performing the positional adjustment of the positional adjustment stage S1 by the positional adjustment device 23 is completed before the transferring and laminating device 24 arrives at the positional adjustment stage S1 and starts the picking-up of the unit electrode assembly 16 therefrom.

At Step 4 subsequent to Step 3, the transferring and laminating device 24 picks up the unit electrode assembly 16 on the positional adjustment stage S1, and transfers the unit electrode assembly 16 to the laminating stage S2 and perform the lamination process with the unit electrode assembly 16. If there is no unit electrode assemblies 16 on the laminating stage S2, the lamination process places the unit electrode assembly 16 on the laminating stage S2. If there is a unit electrode assembly 16 already placed on the laminating stage S2, the lamination process stacks the transferred unit electrode assembly 16 onto the unit electrode assembly 16 already placed on the laminating stage S2.

By repeating the processes of Step 1 to Step 4, an electrode assembly 10 is manufactured by laminating a plurality of the unit electrode assemblies 16 substantially at the same position on the laminating stage S2. The electrode assembly 10 can be manufactured in such a manner that, after a predetermined number of unit electrode assemblies 16 are laminated, the unit electrode assemblies 16 are pressured-bonded altogether.

In general, it is noted that the present invention is not limited to the aforementioned exemplary embodiment, and may be modified or changed in various ways within the scope of the present invention.

For example, while the embodiment explains the manufacturing device 100 for an electrode assembly as including the lighting device 25, it is possible to omit the lighting device 25 as long as it is possible to capture an image, from which the position and the inclination of the electrode 15 can be determined.

Moreover, while the sucking chamber 32 of the transferring device 21 is explained as being transparent, the sucking chamber 32 may be opaque as long as an image of part of the electrode 15 of the unit electrode assembly 16 can be captured through the transparent portion 31a of the sucking plate 30 using the image capturing device 22. For example, when the electrode 15 is larger in size than the sucking chamber 32 in planer view, it is possible to capture an image of the outer shape of the electrode 15 from above even if the sucking chamber 32 overlaps with the electrode 15. Therefore, in such a case, the sucking chamber 32 may be opaque.

### DESCRIPTION OF REFERENCE SYMBOLS

10 Laminated body
11: Positive electrode
12: Negative electrode
13: Separator
15: Electrode
16: Unit electrode assembly
21: Transferring device
22: Image capturing device
23: Positional adjustment device
24: Transferring and laminating device
24a: Sucking pad
25: Lighting device
30: Sucking plate
31: Flat plate portion
31a: Transparent portion
31b: Sucking pore
32: Sucking chamber
32a: Sucking hose opening
100: Manufacturing device
S1: Positional adjustment stage
S2: Laminating stage

1. A manufacturing device for manufacturing an electrode assembly by laminating a plurality of unit electrode assemblies each having an electrode adhered to a separator, the manufacturing device comprising:
a positional adjustment stage;
a transferring device including a sucking plate and configured to transfer each of the unit electrode assemblies sucked up by the sucking plate onto the positional adjustment stage;
an image capturing device configured to capture an image of the electrode of each of the unit electrode assemblies transferred onto the positional adjustment stage;
a positional adjustment device configured to positionally adjust the positional adjustment stage based on the captured image of a respective electrode for each of the unit electrode assemblies transferred onto the positional adjustment stage; and
a transferring and laminating device configured to pick up each of the unit electrode assemblies from the positional adjustment stage, transfer each of the unit electrode assemblies to a laminating position, and perform a lamination process with each of the unit electrode assemblies,
wherein at least part of the sucking plate is a transparent portion, and
wherein the image capturing device is configured to capture the image, such that the image capturing device captures the respective image of at least part of the electrode of each of the unit electrode assemblies on the positional adjustment stage from above via the transparent portion of the sucking plate.

2. The manufacturing device according to claim 1, wherein the image capturing device is configured to capture the respective image of the electrode of each of the unit electrode assemblies when held between the positional adjustment stage and the sucking plate.

3. The manufacturing device according to claim 1, wherein the positional adjustment device is configured to start positionally adjusting the positional adjustment stage while the transferring device is withdrawing after the transferring device transfers each of the unit electrode assemblies onto the positional adjustment stage.

4. The manufacturing device according to claim 1, wherein the positional adjustment stage is transparent or translucent.

5. The manufacturing device according to claim 4, wherein the manufacturing device further comprises a lighting device configured to emit illuminating light to each of the unit electrode assemblies from below the positional adjustment stage when the image capturing device captures the image.

6. The manufacturing device according to claim 1, wherein the sucking plate of the transferring device includes a flat plate and a sucking chamber that includes a sucking hose opening coupled to a sucking hose for sucking up each of the unit electrode assemblies.

7. The manufacturing device according to claim 6, wherein the sucking chamber includes the transparent portion of the sucking plate, and wherein a plurality of sucking pores extend through the flat plate for sucking up each of the unit electrode assemblies.

8. The manufacturing device according to claim 6, wherein the sucking hose opening is not transparent and is positioned such that sucking hose opening will not disturb the image capturing device from capturing the image of the respective electrode of each of the unit electrode assemblies.

9. The manufacturing device according to claim 1, wherein the transparent portion of the of the sucking plate comprises at least one of an acrylic resin, a polyethylene terephthalate resin, a polycarbonate resin, a vinyl chloride resin and glass.

10. A manufacturing device for manufacturing an electrode assembly including a plurality of unit electrode assemblies each having an electrode adhered to a separator, the manufacturing device comprising:
a positional adjustment stage;
a transferring device configured to transfer each of the unit electrode assemblies onto the positional adjustment stage, with the transferring device including a transparent portion;
an image capturing device configured to capture an image of the electrode of each of the unit electrode assemblies when disposed on the positional adjustment stage from above via the transparent portion of the transferring device; and
a positional adjustment device configured to positionally adjust the positional adjustment stage based on the captured image of the respective electrode for each of the unit electrode assemblies transferred onto the positional adjustment stage.

11. The manufacturing device according to claim 10, further comprising a transferring and laminating device configured to pick up each of the unit electrode assemblies from the positional adjustment stage, transfer each of the unit electrode assemblies to a laminating position, and perform a lamination process with each of the unit electrode assemblies.

12. The manufacturing device according to claim 10, wherein the image capturing device is configured to capture the respective image of the electrode of each of the unit electrode assemblies when held between the positional adjustment stage and the transferring device.

13. The manufacturing device according to claim 10, wherein the positional adjustment device is configured to start positionally adjusting the positional adjustment stage while the transferring device is withdrawing after the transferring device transfers each of the unit electrode assemblies onto the positional adjustment stage.

14. The manufacturing device according to claim 10,
wherein the positional adjustment stage is transparent or translucent, and
wherein a lighting device is disposed below the positional adjustment stage and configured to emit light to each of the unit electrode assemblies when the image capturing device captures the image.

15. The manufacturing device according to claim 10, wherein the transferring device includes a sucking plate comprised of a flat plate and a sucking chamber that includes a sucking hose opening coupled to a sucking hose for sucking up each of the unit electrode assemblies.

16. The manufacturing device according to claim 15, wherein the sucking hose opening is not transparent and is positioned such that sucking hose opening will not disturb the image capturing device from capturing the image of the respective electrode of each of the unit electrode assemblies.

17. A method for manufacturing an electrode assembly including a plurality of unit electrode assemblies each having an electrode adhered to a separator, the method comprising:
transferring, by a transferring device, each of the plurality of unit electrode assemblies onto a positional adjustment stage, with the transferring device including a transparent portion;
capturing, by an image capturing device, an image of the electrode of each of the unit electrode assemblies when disposed on the positional adjustment stage from above via the transparent portion of the transferring device; and
positionally adjusting the positional adjustment stage based on the captured image of the respective electrode for each of the unit electrode assemblies transferred onto the positional adjustment stage.

18. The method according to claim 17, further comprising:
picking up each of the unit electrode assemblies from the positional adjustment stage;
transferring each of the unit electrode assemblies to a laminating position; and
performing a lamination process with each of the unit electrode assemblies.

19. The method according to claim 17, further comprising capturing the respective image of the electrode of each of the unit electrode assemblies when held between the positional adjustment stage and the transferring device.

20. The method according to claim 17, further comprising starting the positionally adjusting of the positional adjustment stage while the transferring device is withdrawing after transferring each of the unit electrode assemblies onto the positional adjustment stage.
